(19) United States
(12) Patent Application Publication
(10) Pub. No.: US 2025/0174767 A1
(43) Pub. Date: May 29, 2025

(54) THERMAL MANAGEMENT ASSEMBLY COMPRISING EXPANDABLE MATERIAL

(71) Applicant: 3M INNOVATIVE PROPERTIES COMPANY, Saint Paul, MN (US)

(72) Inventors: Jacob P. Podkaminer, St. Paul, MN (US); Matthew H. Frey, Cottage Grove, MN (US); Victor Ho, St. Paul, MN (US); Matthew T. Johnson, Woodlbury, MN (US); Alexander J. Bourque, St. Paul, MN (US); Samuel J. Carpenter, St. Paul, MN (US); Brandon A. Bartling, Woodbury, MN (US); Zhou Jin, Shanghai (CN); Marc T. Dunham, Golden Valley, MN (US)

(21) Appl. No.: 18/834,410

(22) PCT Filed: Mar. 3, 2023
(86) PCT No.: PCT/IB2023/051998

§ 371 Date: Jul. 30, 2024

Related U.S. Application Data
(60) Provisional application No. 63/317,685, filed on Mar. 8, 2022.

(51) Int. Cl. H01M 10/658; H01M 10/613

(52) U.S. Cl. CPC H01M 10/658; H01M 10/613

(57) ABSTRACT

A thermal management assembly is described comprising a first thermal pathway comprising a first expandable material disposed between a first electrochemical cell and a first heat exchange member; and a second thermal pathway comprising a second expandable material disposed between a second electrochemical cell and a second heat exchange member. The first and second expandable material independently comprise intumescent particles dispersed in an organic binder and the first and second expandable materials expand at a first expansion temperature range and a second expansion temperature range respectively. Also described are methods of using of a thermal management assembly and methods of making a thermal management assembly.

### BACKGROUND

Battery lifetime and reliability are critical metrics for next-generation electric vehicles. These measures are a function of the thermal history experienced by each electrochemical cell in the battery during operation because elevated temperatures can cause undesired irreversible electrochemical reactions that decrease its capacity. Therefore, ideally each cell in the battery would experience identical thermal histories and thereby age to the same degree. To achieve this, batteries should be in constant thermal contact during normal operation to increase the effective thermal mass of each cell. This can spread any transient thermal spikes of an individual cell over the entire battery module or pack.

However, in the situation where the thermal energy released from the electrochemical reaction surpasses the heat removal rate, termed self-heating, auto-acceleration of reactions can lead to catastrophic failure, termed a runaway event. If this occurs, and all cells of a module are in thermal communication, then a single cell can initiate runaway for neighboring cells and failure or even combustion of the entire pack is accelerated. The cascade of thermal runaway from one cell to a neighboring cell is called thermal runaway propagation. Industry would find advantage in thermal management assemblies directed at delaying or preventing thermal runaway propagation.

### SUMMARY

In one embodiment, a thermal management assembly is described comprising a first thermal pathway comprising a first expandable material disposed between a first electrochemical cell and a first heat exchange member; and a second thermal pathway comprising a second expandable material disposed between a second electrochemical cell and a second heat exchange member. The first and second expandable material independently comprise intumescent particles dispersed in an organic binder and the first and second expandable materials expand at a first expansion temperature range and a second expansion temperature range respectively.

In some embodiments, the first and/or second expandable materials further comprise thermally conductive particles. In some embodiments, one or more (e.g. non-expandable) thermal conductor(s) are in contact with the expandable material.

In typical embodiments, the first and second heat exchange members are the same heat exchange member are portions of a contiguous heat exchange member. In some embodiments, the first and second expandable materials are portions of a contiguous expandable material.

When heated to a first temperature of the first expansion temperature range, the first expandable material expands thereby decreasing in apparent thermal conductivity and the first thermal pathway increases in thermal impedance. In some embodiments, the first expandable material expands such that it delaminates from the electrochemical cell, heat exchange member, and/or thermal conductor.

When heated to a second greater temperature, the first expandable material contracts thereby increasing in apparent thermal conductivity and the first thermal pathway decreases in thermal impedance.

Also described are methods of using of a thermal management assembly and methods of making a thermal management assembly.

### BRIEF DESCRIPTION OF THE DRAWINGS

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

FIG. 1 is a schematic side view of a representative thermal management article comprising a thermally conductive layer comprising intumescent particles.

FIG. 2 is a schematic side view of another thermal management article.

FIG. 3 is a schematic process flow diagram showing thermally induced shear delamination of thermal management article.

FIG. 4 is a graph of thermal impedance as a function of temperature.

FIG. 5 is schematic side views showing the thermal pathways at different temperatures of electrochemical cells disposed on a heat exchange member (e.g. cold plate) with an expandable material having thermal impedance properties illustrated by EX. 5 of FIG. 4.

FIGS. 6-9 are schematic side views of thermal management assemblies with thermal pathways between electrochemical cells and a heat exchange member.

FIG. 10 is a schematic side view of an exemplary thermal management assembly comprising an additional thermal pathway between the electrochemical cells.

FIG. 11 is a schematic side view of an exemplary composite thermal management article 1100 according to the present disclosure.

### DETAILED DESCRIPTION

Unless otherwise noted, as used herein:
the term “battery module” refers to an assembly of two or more electrically connected electrochemical cells having positive and negative electrodes; and
the term “thermally conductive” means having a thermal conductivity of at least 0.5 watt per meter-kelvin (i.e., W/mK or equivalently W·m⁻¹K⁻¹) at 50° C.;
the term “thermal impedance” is defined for a thermal pathway as the sum of the thermal resistance of a material or materials of the pathway plus any thermal resistance contributions from interfaces made between the material or materials and a heat source and heat sink of the pathway; and

The term “apparent thermal conductivity” is defined for a material or materials of a thermal pathway as the value of thermal conductivity calculated from the thermal impedance

Features and advantages of the present disclosure will be further understood upon consideration of the detailed description as well as the appended claims.

Presently described is a thermal management assembly comprising a first thermal pathway comprising a first expandable material disposed between a first electrochemical cell and a first heat exchange member; and a second thermal pathway comprising a second expandable material disposed between a second electrochemical cell and a second heat exchange member. The first and second expandable materials independently comprise intumescent particles dispersed in an organic binder and the first and second expandable materials expand at a first expansion temperature range and a second expansion temperature range respectively.

Thus, the thermal management assembly described herein initially operates on the principle of expansion.

The shape of the expandable material may vary depending on the application method. In the case of film and sheet materials including tapes, the expandable material is typically a thin layer of uniform thickness. The layer may be continuous (in length, width, and thickness) between the electrochemical cell and the heat exchange member. The layer may be continuous or discontinuous with respect to the surface of the heat exchange member. In some embodiments, the electrochemical cells may be encased in the expandable material except for the terminals.

With reference to FIG. 1, thermal management article 100 comprises an expandable material 24. Expandable material 24 comprises intumescent particles 45 and thermally conductive particles 46 retained in an organic polymer binder 35. Upon heating, the first and second expandable materials expand at an expansion temperature range due to the expansion of the intumescent particles.

In some preferred embodiments, shear delamination occurs at a thermally interruptible interface due to expansion of the intumescent particles that results in debonding of the expanded expandable material from whatever element that it is bonded to, and which forms the thermally interruptible interface. Commonly, such shear delamination is readily visually detectable by an unaided human eye with 20/20 vision, but may be enhanced by microscopic inspection. Thus, in some embodiments, the thermal management article of FIG. 1 may shear delaminate from the heat exchange member and/or electrochemical cell.

In other embodiments, the thermal management assembly operates on the principle of shear delamination between two different materials (e.g., expandable layers) along a thermally interruptible interface. Shear delamination occurs when heating to at least an onset temperature range of the expansion temperature range causing intumescent particles in one expandable material (e.g., expandable layer) to expand. This expansion causes shear strain at the interface and results in delamination and formation of at least one gap at the thermally interruptible interface that increases the thermal resistance across the thermally interruptible interface, and hence also increases the thermal impedance of the thermal pathway. Advantageously, shear delamination can occur even when the expandable material is present as a thin layer, which is amenable for applications where space is limited.

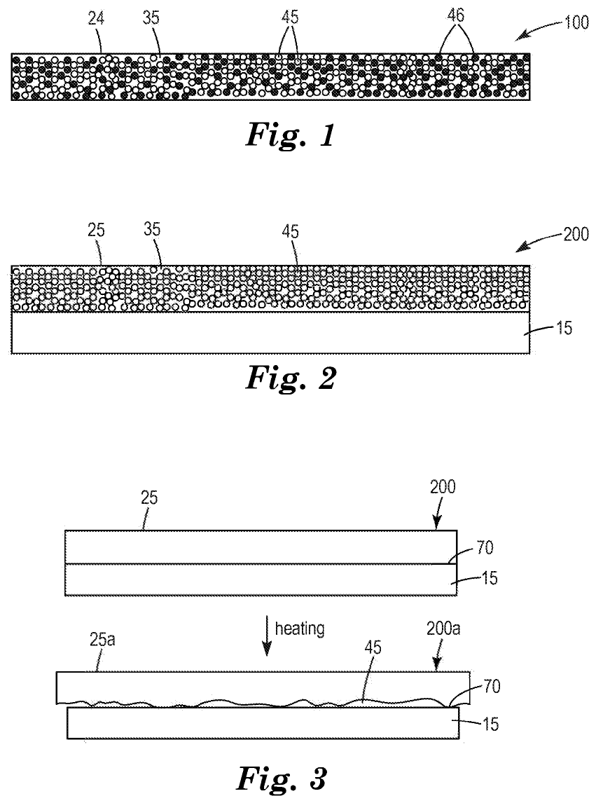

With reference to FIGS. 2-3, composite (e.g. multi-layer) thermal management article 200 comprises an expandable material (e.g. layer) 25. Expandable material 25 comprises intumescent particles 45 retained in an organic polymer binder 35. Thermal conductor material 15 contacts expandable material 25 at thermally interruptible interface 70. Upon heating, the intumescent particles in the expandable material 25 expand at temperatures of the expansion temperature range. The thermal conductor material (e.g. layer) 15 is typically non-expandable, lacking intumescent particles. The difference in expansion properties of the expandable material and contacting surface of the thermal conductor, heat exchange member, and/or electrochemical cell is amenable to the expandable material delaminating from the contacting surface.

The thickness of the expandable materials (e.g. expandable layers), 24 and 25, is typically at least 50, 100, 150, 200, 250, 300, 350, 400, 450, or 500 microns. The thickness of the expandable material or expandable layer is typically no greater than 5, 4, 3, 2, or 1 mm.

Referring now to FIG. 3, in some embodiments, thermal management article 200 is transformed into thermal management article 200a by heating to at least the minimum onset temperature of the intumescent particles, whereupon the intumescent particles of expandable layer 25 expand forming expanded layer 25a creating shear stress along the thermally interruptible interface 70, and ultimately causing shear delamination and formation of gaps 45. By this process, heat flow from the expandable material to the thermal conductor material across the thermally interruptible interface is reduced (i.e., thermal resistance of the thermally interruptible interface is increased). Various embodiments of a thermal management assembly and composite thermal management article comprising a thermally interruptible interface are described in PCT/IB2021/057275 (83207WO003).

In some embodiments, the thermal management articles, such as illustrated by FIGS. 1 and 2, may further comprise an adhesive layer such as a curable, hot melt and/or pressure sensitive adhesive. When a pressure sensitive adhesive is present, the article may further comprise a release liner.

One embodiment of a composite (e.g. multi-layer) thermal management article further comprising an adhesive is shown in FIG. 11. Referring now to FIG. 11, composite thermal management article 1100 comprises layer of expandable material 25. Expandable material 25 comprises intumescent particles 45 retained in an organic polymer binder 35 (see FIG. 1). Optional layer of thermal conductor material 15 contacts the layer of expandable material 25 at thermally interruptible interface 70. First adhesive layer 1130a, which may be, for example, a hot melt and/or pressure-sensitive adhesive layer, is disposed on layer of thermal conductor material 15 opposite the layer of expandable material 25. Optional first release liner 1140a is releasably adhered to adhesive layer 1130a. Optional second adhesive layer 1130b, which may be, for example, a curable, hot melt and/or pressure-sensitive adhesive layer independent from first adhesive layer 1130a, is disposed on layer of expandable material 25 opposite layer of thermal conductor material 15. Optional second release liner 1140b is releasably adhered to adhesive layer 1130b. Upon heating, the intumescent particles in the layer of expandable material 25 expand. Another embodiment of a thermal management article comprises article 100 of FIG. 1 in place of layers 15 and 25 of FIG. 11.

Pressure-sensitive adhesives (e.g., acrylic pressure-sensitive adhesives), and hot melt adhesives (e.g., styrene-block-butadiene-block-styrene (SBS) copolymer hot melt adhesives) are widely available from commercial sources, and selection of them is within the capability of those of ordinary skill in the art. The composite thermal management article may be provided in any form; for example, a sheet or in other words film, a stack of sheets, or a roll.

The expandable material may comprise a composite of an organic polymer and intumescent particles. Exemplary organic polymers include acrylic polymers (e.g., polymethyl methacrylate, polyethyl acrylate, polyacrylonitrile), polyolefins (e.g., polyethylene, high molecular weight (HMW) polyethylene ultra high molecular weight (UHMW) polyethylene polypropylene, polybutadiene, ethylene-propylene copolymers, and ethylene-propylene diene rubbers (EPDM)), styrenic polymers (e.g., polystyrene, acrylonitrile butadiene styrene (ABS), polyvinyl ethers, silicones, polyurethanes, polyethers, polyamines, polyamides, polyesters, polycarbonates, liquid crystalline polymers, and combinations thereof. Such materials are widely available for commercial sources. The organic polymer may be linear, chemically crosslinked, or it may comprise a mixture of both types of organic polymers.

The organic polymer may be melt-processed (e.g., by extrusion), solvent borne, and/or at least partially cured curable resins. If the average number of polymerizable groups per polymerizable compound is greater than one, then chemically crosslinked polymers can be achieved through curing. Suitable curable resins may include, for example, epoxy resins, urethane resins, ring-opening metathesis polymerization (ROMP) cycloolefin resins, isocyanurate resins, free-radically polymerizable resins (e.g., mono- and/or polyfunctional acrylates, methacrylates, acrylamides, vinyl ethers, and/or maleates), phenolic resins, urea-formaldehyde resins, aminoplast resins, silicone resins, and self-crosslinking polymer latexes. In some cases, a curative such as, for example, a free-radical initiator (thermal initiator or photoinitiator), amine crosslinker, and/or acid catalyst is typically used in combination with the curable resin. The selection of a curative and relative amounts to be used, as well as curing conditions, are within the capabilities of those of ordinary skill in the art.

In some embodiments, the organic binder has a Tg less than 25° C. or 0° C. In some embodiments, the Tg of the organic binder may be less than −25° C. or −50° C. In this embodiment, the organic polymer may be a free-radically cured (e.g. acrylic) polymer. The acrylic polymer may comprise one or more (meth)acrylate monomers cured by exposure to (e.g. ultraviolet) actinic radiation. For example, a homopolymer of ethyl hexyl acrylate has a Tg of −50° C. The organic polymer may be characterized as a pressure sensitive adhesive. Acrylic pressure sensitive adhesives can be provided as a film or tape, facilitating the method of making the thermal management assembly. In this embodiment, the organic polymer is not a moisture cured urethane resin, (e.g. room temperature) cured epoxy resin, or cured silicone oil. Thus, in some embodiments, the organic binder lacks siloxane moieties.

Intumescent particles useful in practice of the present disclosure are typically particulate materials that expand to many times their original size when heated to a temperature or temperatures of an expansion temperature range. The expansion temperature range of intumescent particles extends from a minimum expansion temperature to a maximum expansion temperature. The minimum expansion temperature of the expansion temperature range of intumescent particles is typically referred to as the onset temperature range Tonset (or expansion start temperatures). The expansion temperature range of the intumescent particles also includes a maximum expansion temperature range.

Examples of intumescent particles include heat expandable polymeric microspheres (e.g., as available under the trade designations EXPANCEL DU from Nouryon, Amsterdam, The Netherlands, and DUALITE U from Chase Corp., Westwood Massachusetts), perlite, unexpanded vermiculite, intumescent graphite, ammonium polyphosphate, sodium silicates, hydrobiotite, and water swellable synthetic tetrasilicic fluorine-type mica described in U.S. Pat. No. 3,001,571 (Hatch), and combinations thereof. Of these, expandable polymer microspheres are typically preferred when a low onset temperature is desired or in other words it is desired that the expansion of the intumescent particles occurs at lower temperatures.

Commercially available grades of DUALITE expandable polymer microspheres include U020-125W (Tₒₙₛₑₜ=85-90° C.); U018-130W (Tₒₙₛₑₜ=90-95° C., Tₘₐₓ=130-140° C.); U015-135D (Tₒₙₛₑₜ=95-100° C., Tₘₐₓ=135-145° C.); U024-145W (Tₒₙₛₑₜ=115-120° C., Tₘₐₓ 145-155° C.); U005-190W (Tₒₙₛₑₜ=130-135° C., Tₘₐₓ=190-200° C.); U017-175W (Tₒₙₛₑₜ 140-145° C., Tₘₐₓ=175-185° C.); U010-185W (Tₒₙₛₑₜ=145-150° C., Tₘₐₓ=185-195° C.); and U010-190W (Tₒₙₛₑₜ=130-135° C., Tₘₐₓ=190-200° C.). The same DUALITE expandable polymer microspheres are supplied as a wet cake (designation “W”) and dry (designation “D”). Commercially available grades of EXPANCEL DU expandable polymer microspheres include FG52 DU 80 (Tₒₙₛₑₜ=94-105° C.); FG92 DU 120 (Tₒₙₛₑₜ=122-132° C.); 642 WU 40 (Tₒₙₛₑₜ=87-93° C.); 551 WU 40 (Tₒₙₛₑₜ=94-99° C.); 461 WU 20 (Tₒₙₛₑₜ=100-106° C.); and 909 WU 80 (Tₒₙₛₑₜ=120-130° C.).

Commercially available grades of expandable polymer microspheres typically have an onset temperature of at least 80 or 85° C. The maximum temperature of the expansion temperature range is typically no greater than 285, 275 or 250° C. In some embodiments, the expansion temperature range has a maximum of less than 250, 225, 200, or 175° C. In some embodiments, the expansion temperature range has a maximum of less than 155, 150, 145, or 140° C. In some embodiments, the expansion temperature range of the intumescent particles has an onset temperature range with a minimum of less than 110, 105, 100, 95, 90, 85, or 80° C.

The expansion temperature range of the expandable microspheres is related to the size of the expandable microspheres, the blowing agent inside the microspheres, the thickness of the shells, as well as the shell material. For example, acrylonitrile co-polymer shells typically have higher onset temperature ranges than polyvinylidene dichloride shells. Thus, in some favored embodiments, the expandable material comprises expandable polymer microspheres comprising polyvinylidene dichloride shells.

Expandable materials are also describable by an expansion temperature range (expansion temperature range of an expandable material). The expansion temperature range of an expandable material extends from a minimum expansion temperature to a maximum expansion temperature. The minimum expansion temperature of the expansion temperature range of an expandable material is typically referred to as the onset temperature range Tₒₙₛₑₜ (or expansion start temperatures). The expansion temperature range of an expandable material also includes a maximum expansion temperature range. In some embodiments, the expansion temperature range of the expandable material is the same as the onset temperature range of the intumescent particles (e.g., expandable polymer microspheres).

In other embodiments, the expansion temperature range of the expandable material is a range including the onset temperature range and the maximum temperature range of the intumescent particles (e.g., expandable polymer microspheres).

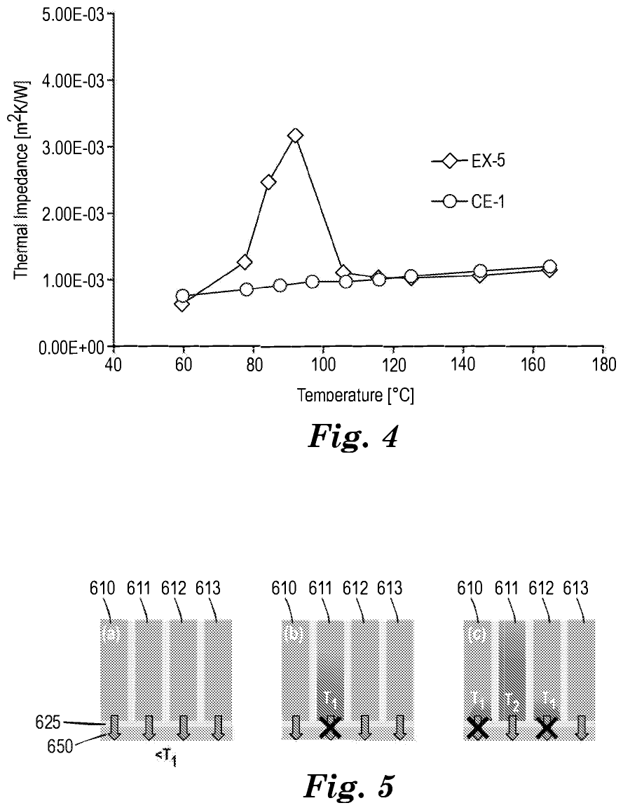

Lower onset temperature ranges are amenable to delaying or preventing thermal runaway at lower temperatures. Therefore, expansion of the intumescent particles occurs sooner as a function of time. Expandable polymer microspheres may be characterized as irreversibly expandable at or above their onset temperature. After being expanded, reducing the temperature alone typically does not result in appreciable contraction of the polymer microspheres to their unexpanded size. However, as evident by FIG. 4, increasing the temperature of the expanded material to a second greater temperature (e.g. above the onset temperature range) can cause a reduction in thermal impedance. Thus, at such higher second temperature(s) the expandable microspheres are collapsing and/or contracting in size. In some embodiments, the expandable polymer microspheres may be at least partially melting. The expandable material, comprising the collapsed and/or contracted polymer microspheres, also has a higher density compared with the expandable material at the onset temperature range.

When an electrochemical cell is heated to a second greater temperature, the expandable material contracts thereby increasing in apparent thermal conductivity. The (e.g. first) thermal pathway is decreasing in thermal impedance. The second temperature is typically above the onset temperature range of the expandable polymer microspheres. In some embodiments, the second temperature is above the maximum temperature of the expansion temperature range. In some embodiments, the second (e.g. contraction) temperature is less than 200, 190, 180, 170, 160, 150, 140, 130, 120, 110 or 110° C. Preferably the binder material is capable of deforming as the expandable microspheres collapse at the second temperature. Furthermore, in cases where the expandable material shear delaminates (e.g. at a thermally interruptible interface), thermal contact is preferably reestablished at the second temperature.

To enhance the contraction of intumescent particles and/or the reestablishment thermal contact of the thermally interrupted interface at the second temperature, pressure may be (e.g., uniaxially) applied to the expandable. The applied pressure may be at least 1, 2, 3, 4, or 5 kPa and is typically no greater than 1 MPa, 500 kPa, 100 kPa, 50 kPa, 25 kPa, or 15 kPa. In some embodiments, the pressure is applied by the weight (mass and gravity) of the electrochemical cell on the expandable material. In typical embodiments, the thermal management assembly is within a housing of a battery module. In this embodiment, pressure can be applied by overall thermal expansion of the thermal management assembly constrained by the housing.

Thus, although the thermal management assembly initially operates on the principle of expansion, the thermal management assembly also operates on the principle of contraction that is amenable to increasing the apparent thermal conductivity of the expandable material an decreasing the thermal impedance of the thermal pathway at higher temperatures than the expansion temperature range of the expandable materials.

With reference to FIG. 4 and Table 3, the expandable material can first decrease in apparent thermal conductivity thus increasing the thermal impedance of a thermal pathway by at least 1E-03 (i.e. 1×10⁻³) m²K/W. In some embodiments, the increase in thermal impedance is at least 2E-03 m²K/W, 3E-03 m²K/W, or 4E-03 m²K/W. The expandable material can also decrease in apparent thermal conductivity thus decreasing the thermal impedance of the thermal pathway at a second greater temperature. At such second greater temperature, the expandable material can decrease in thermal impedance by at least 1E-03 (i.e. 1×10⁻³) m²K/W. In some embodiments, the decrease is at least 2E-03 m²K/W, 3E-03 m²K/W, or 4E-03 m²K/W.

With reference to Table 4 the thermal pathway(s) increase in thermal impedance by at least 50, 100, 200, 300, or 400% when the intumescent particles and expandable material are expanding at temperatures of the expansion (e.g. onset) temperature range of the expandable material. The thermal pathway(s) decrease in thermal impedance by at least 25, 50 or 75% when the intumescent particles and expandable material are contracting at temperatures greater than the expansion temperature range of the expandable material.

The expandable material of EX-5 of FIG. 4 comprises expandable polymer microspheres reported to have an expansion onset temperature of 90-95° C. and a maximum expansion temperature of 130-140° C. Notably, the thermal impedance sharply rises at 80° C. The thermal impedance peaks at the maximum of the onset temperature range of the expandable microspheres. In this particular embodiment, thermal impedance does not increase at temperatures above 95° C., ranging to 130-140° C. Notably, the decrease in thermal impedance occurs when the temperature is greater than the maximum temperature of the onset temperature range, (95° C. in this example). Thus, in this embodiment, the expandable polymer microspheres are not expanding throughout the entire expansion temperature range reported for the expandable polymer microspheres. Further, the expansion temperature range of the expandable material is not the same as the expansion temperature range of the expandable polymer microspheres. Without intending to be bound by theory, the expansion properties of the expandable polymer microspheres are affected by i) the shell material and blowing agent of the expandable polymer microspheres; ii) the organic resin of the expandable material surrounding the expandable polymer microspheres; and iii) any pressure applied to the expandable material comprising the expandable polymer microspheres. Thus, depending on these factors, it is surmised that other expandable polymer microspheres incorporated into expandable materials, and in some cases undergoing applied pressure, may expand at temperatures greater than the onset temperature, yet less than the maximum expansion temperature.

With reference to FIG. 5(a), when the temperature of the thermal management assembly is less than the expansion temperature of the expandable material 625 (<T₁) disposed between the electrochemical cells 610, 611, 612, and 613 and the heat exchange member 650, each of the thermal pathways, depicted by arrows, extend from the electrochemical cells through the expandable material 625 to the heat exchange member, are characterized as “on”. Expandable material 625 can be expandable material 24 or 25. In some embodiments, the first and second expandable materials are portions of a contiguous expandable material, such as a continuous layer, as shown in FIG. 5. Alternatively, the first and second expandable material can be discontiguous as shown in FIGS. 6-10. One or more thermal conductors as well as more than one expandable material can be present, as depicted in forthcoming FIGS. 6-10. With reference to FIG. 5(b), when the temperature of an electrochemical cell 611 begins to overheat and reaches the expansion temperature range (T₁) of the intumescent particles and the expandable material 625 expands thereby decreasing in apparent thermal conductivity and increasing the thermal impedance of the thermal pathway between such electrochemical cell 611 and heat exchange member 650. The reduction in apparent thermal conductivity and increase in thermal impedance is indicated by “X” in FIG. 5(b) and may also be characterized as switching “off” the thermal pathway. With reference to FIG. 5(c), when the temperature of an electrochemical cell 611 continues to overheat and reaches a temperature (referred to herein as a second temperature) greater than the maximum expansion temperature (T₂) of the expanded material 625, the expandable material contracts thereby increasing in apparent thermal conductivity and decreasing the thermal impedance of the thermal pathway between such electrochemical cell 611 and heat exchange member 650. Thus, this thermal pathway is switched “on” again, depicted by the arrow extending from the electrochemical cell 611 through the expandable material to the heat exchange member in FIG. 5(c). Thus, excess heat is being allowed again to be transferred to the heat exchange member and its optional coolant. With further reference to FIG. 5(c), the expandable material 625 placed within the thermal pathways between the heat exchange member and neighboring cells 610 and 612 reach the expansion temperature range (T₁) of the expandable material. Thus, expandable material 625 expands thereby reducing in apparent thermal conductivity and/or increasing the thermal impedance of the thermal pathways between such electrochemical cells 610 and 612 and heat exchange member 650. In other words, the thermal pathway of one or more electrochemical cells (e.g., 610, 612) is switched off concurrently with the thermal pathways of one or more other electrochemical cells (e.g., 611) being switched on.

Inorganic intumescent particles such as perlite, unexpanded vermiculite, intumescent graphite, ammonium polyphosphate, sodium silicates, hydrobiotite, and water swellable synthetic tetrasilicic fluorine-type mica typically have considerably higher expansion temperature ranges than expandable polymer microspheres. Inorganic intumescent particles also typically have higher decomposition temperatures. For example, graphite decomposes at 700-900° C. Further, inorganic intumescent particle may not contract at a suitable temperature to allow for reconnection of a thermal pathway between an electrochemical cell and a heat exchange member. Thus, the presence of inorganic intumescent particles can detract from the physical property of reducing the thermal impedance and increasing in apparent thermal conductivity at lower temperatures. Thus, in favored embodiments, the expandable material comprises expandable polymer microspheres particles dispersed in an organic binder and comprises little or no non-conductive inorganic intumescent particles, such as intumescent graphite. Thus, in some embodiments, the concentration of such inorganic intumescent particles (e.g. expandable graphite) is typically less than 30, 25, 20, 15, 10, 5, or 1 wt. % of expandable graphite based on the total amount of intumescent particles. In these embodiments, the expandable material typically comprise greater than 70, 75, 80, 85, 90, 95, or 99 wt. % of polymeric microspheres based on the total amount of intumescent particles.

The intumescent particles may have any desired particle size. In some embodiments, the intumescent particles have a volume average particle diameter in the range of 0.01 to 500 microns, preferably 0.1 to 150 microns. The amount of intumescent particles is typically at least 10 volume percent, at least 20 volume percent, at least 30 volume percent, at least 40 volume percent, or even more preferably greater than 50 volume percent based on the total volume of the expandable material.

The weight percent of the intumescent particle can vary depending on the density. In the case of expandable polymer microspheres, the amount of expandable polymer microspheres is typically at least 0.1, 0.2, 0.3, 0.5, 0.5, 0.6, 0.7, 0.8, 0.9, or 1 wt. % of the expandable material. In some embodiments, the expandable polymer microspheres is at least 2, 3, 4, or 5 wt. % of the expandable material. In some embodiments, the expandable polymer microspheres is at least 10, 15, or 20 wt. % of the expandable material. Expandable polymer microspheres typically have a density of about 1 g/cc prior to expansion. Thus, 50 volume percent of expandable polymer microspheres is equivalent to about 50 wt. % of expandable polymer microspheres when dispersed in a polymer binder with the same density. In some embodiments, the amount of expandable polymer microspheres is no greater than 45, 40, 35, 30, 25, or 20 wt. % of the expandable material.

The amount of expandable polymer microspheres can depend on whether the expandable material is a single layer as depicted in FIG. 1 or a multi-layer as depicted in FIG. 2. In the case of a single layer, the volume percent of expandable microspheres is typically lower than the thermal filler in order that the expandable material is also sufficiently thermally conductive. In this embodiment, the amount of expandable polymer microspheres is typically less than 25 volume percent.

The expandable material may have a lower apparent thermal conductivity than the thermal conductor material (e.g. layer(s)), if present in the thermal pathway, although this is not a requirement. In such embodiments, the expandable material may have an apparent thermal conductivity of 0.9, 0.75, 0.5, or even 0.05 times that of the thermal conductor material (e.g. layer(s).

In some embodiments, a thermal conductor material is present. For example, the expandable material of FIG. 1 may comprise thermally conductive filler in combination with intumescent particles and thus may be characterized as being a thermal conductor material. As yet another example, a (non-conductive) expandable material (e.g. layer) 25 may be provided in a separate layer disposed on thermal conductor material (e.g. layer) 15, as depicted in FIG. 2. The thermal conductor material (e.g. layer), and/or the thermally conductive expandable material or composite of thermal conductor material and (e.g. non-conductive) expandable material may have an apparent thermal conductivity of at least 0.5 watt per meter-kelvin (i.e., W/mK or equivalently W·m⁻¹K⁻¹) at 50° C., more preferably at least 1 Wm⁻¹K⁻¹, at least 2.5 Wm⁻¹K⁻¹, at least 5 Wm⁻¹K⁻¹, at least 10 Wm⁻¹K⁻¹, at least 15 Wm⁻¹K⁻¹, at least 20 Wm⁻¹K⁻¹, or even at least at least 30 Wm⁻¹K⁻¹; however, this is not a requirement, especially if present as a thin layer.

The thermal conductor material may comprise an organic polymer binder, for example, as described with respect to the expandable material.

In some embodiments, the expandable material and/or the thermal conductor material further comprises thermally conductive filler particles (i.e., thermal filler). Any thermal conductive filler may be used including, for example, particles comprising at least one of aluminum oxide (alumina), magnesium oxide, aluminum hydroxide, silicon nitride, zinc oxide, silicon oxide, beryllium oxide, titanium oxide, copper oxide, cuprous oxide, boron nitride, aluminum nitride, silicon carbide, diamond, talc, mica, kaolin, bentonite, magnesite, pyrophyllite, titanium boride, calcium titanate, metal (e.g., copper, aluminum, brass, steel, bronze), graphite, carbon black, graphene, and combinations thereof.

Thermal conductive filler may have any desired particle size. In some embodiments, the thermal filler has a volume average particle diameter in the range of 0.01 to 500 microns, preferably 0.1 to 150 microns. If present, the amount of thermal filler is typically greater than 30 volume percent, preferably greater than 40 volume percent, and more preferably greater than 50 volume percent based on the total volume of thermal conductor material.

Thermal fillers can be readily obtained from commercial vendors, and optionally processed (e.g., milled and/or classified) to provide a desired average particle size.

The expandable material and/or thermal conductor material may further comprise additives such as for example, antioxidants, UV stabilizers, fillers, plasticizers, colorants, flame retardants, and fragrances, if desired.

In some preferred embodiments, the expandable material and/or the thermal conductor material comprises (e.g., has the form of) a thin layer. These embodiments are advantageous, because in-plane expansion (i.e., causing shear force) remains constant but thickness expansion is minimized allowing use in confined spaces.

Preferably, the apparent thermal conductivity between the first electrochemical cell and the heat exchange member (e.g. heat sink) is reduced by at least 50 percent, at least 75 percent, or even at least 90 percent at a temperatures at or above the expansion temperature range of the expandable material.

Preferably, the thermal impedance between the first electrochemical cell and the heat exchange member (e.g. heat sink) is decreased by at least 50 percent, at least 75 percent, or even at least 90 percent at a temperature above the expansion temperature of the expandable material.

In some embodiments, the thermal management assembly includes a thermal pathway that has a thermal impedance of the temperature range from 50-90° C. that is at least 25% less than the thermal impedance of the temperature range from 90-110° C. In some embodiments, the thermal impedance of the temperature range from 50-90° C. can be at least 30, 40, 50, 60, or 70% less than the thermal impedance of the temperature range from 90-110° C. This same thermal impedance reduction can be obtained at other temperatures depending on the selection of intumescent material(s).

In some embodiments, the thermal management assembly includes a thermal pathway that has a thermal impedance of the temperature range from 120-170° C. that is at least 25% less than the thermal impedance of the temperature range from 80-90° C. In some embodiments, the thermal impedance of the temperature range from 120-170° C. can be at least 30, 40, 50, or 60% less than the thermal impedance of the temperature range from 80-90° C. This same thermal impedance reduction can be obtained at other temperatures depending on the selection of intumescent material(s).

In embodiments with expandable material and thermal conductor material (e.g. layers), the total combined volume of the layers preferably increases less than 50 percent, less than 25 percent, or even less than 10 percent at or above the expansion temperature range of the expandable material.

In embodiments having multiple expandable material layers that each contain respective intumescent particles, it is contemplated that the respective intumescent particles in each expandable material layer may have the same or different onset temperatures.

The thermal management assemblies described herein include at least two electrochemical cells.

In some embodiments, the thermal management assemblies described herein include a plurality of electrochemical cells. For example, battery modules in electric vehicles often have tens to hundreds of electrochemical cells. In some embodiment, the two or more electrochemical cells, each having a thermal pathway to the same heat exchange member as depicted in FIGS. 6-10. In other less typical embodiments, the two or more electrochemical cells have thermal pathways to separate heat exchange members.

While any type of electrochemical cell may be used (e.g., galvanic cells, voltaic cells, electrolytic cells, and fuel cells), the present disclosure may have particular applicability to rechargeable electrochemical cells. Exemplary rechargeable electrochemical cells include nickel-cadmium (NiCd), nickel-metal hydride (NiMH), lithium-ion (Li-ion), lithium iron phosphate (LiFePO₄), and lithium-ion polymer (Li-ion polymer) cells. Of these, lithium-containing rechargeable electrochemical cells and batteries containing them are known to experience occasional thermal runaway events due to, for example, internal short circuiting, overcharging and/or physical damage. To reduce these events and for convenience, electrochemical cells (except for the terminal electrodes) are often enclosed and sealed within a casing (battery). Electrochemical cells of any format may be used, including but not limited to cylindrical cells, prismatic cells, and pouch cells.

The heat exchange member may be a heat sink; a device or substance for absorbing excessive or unwanted heat from a heat source. Typically, a heat sink is a passive heat exchanger that transfers the heat generated by an electronic or a mechanical device to a fluid medium, often air or a liquid coolant, where it is dissipated away from the device, thereby allowing regulation of the device's temperature; however, this is not a requirement. In electronic devices a heat sink is usually designed to maximize its surface area in contact with the cooling medium surrounding it, such as the air.

Air velocity, choice of material, protrusion design and surface treatment are factors that affect the performance of a heat sink. Thermal adhesive or thermal grease improve the heat sink's performance by filling air gaps between the heat sink and a heat spreader (e.g., fins) on a device. A heat sink is often made out of aluminum or copper, although other materials may also be used.

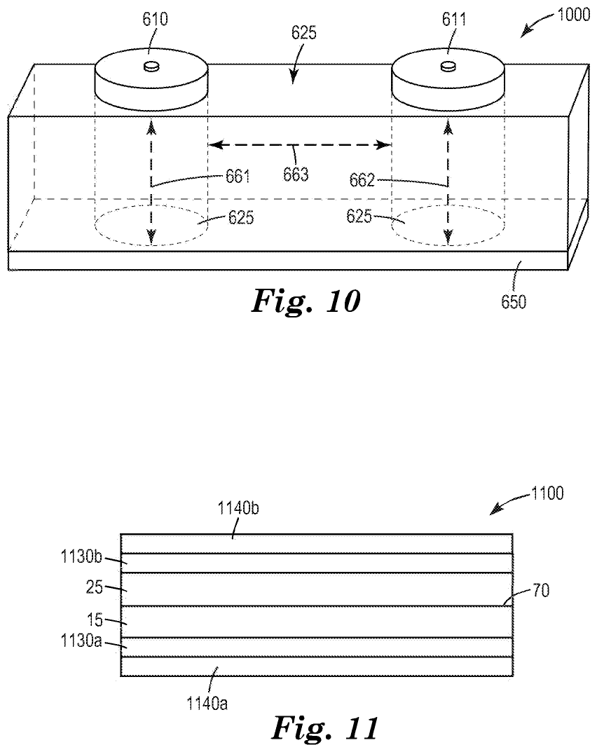

The heat exchanger may be an active heat exchanger comprising circulating coolant. In the present invention the heat exchanger is not another electrochemical cell. However, the thermal management assemblies described herein may also have a third thermal pathway between the electrochemical cells, such as depicted in FIG. 10. The third thermal pathway 663 may comprise an expandable material 625 as described herein between the electrochemical cells in addition to having the expandable material between the electrochemical cells and heat exchange member.

Referring now to FIG. 6, thermal management assembly 600 comprises first electrochemical cell 610 and second electrochemical cell 611. Expandable material 625 is disposed between each electrochemical cell and the heat exchange member 650. Expandable material 625 (such as depicted by thermal management article 100 of FIG. 1) comprises thermally conductive particles and intumescent particles retained in an organic polymer binder (both not shown). Expandable material 625 typically contact and conforms to the surfaces of both the electrochemical cell and the heat exchange member. Thermal pathways 661 and 662 extend from the electrochemical cells to the heat exchange member 650 passing through expandable material 625.

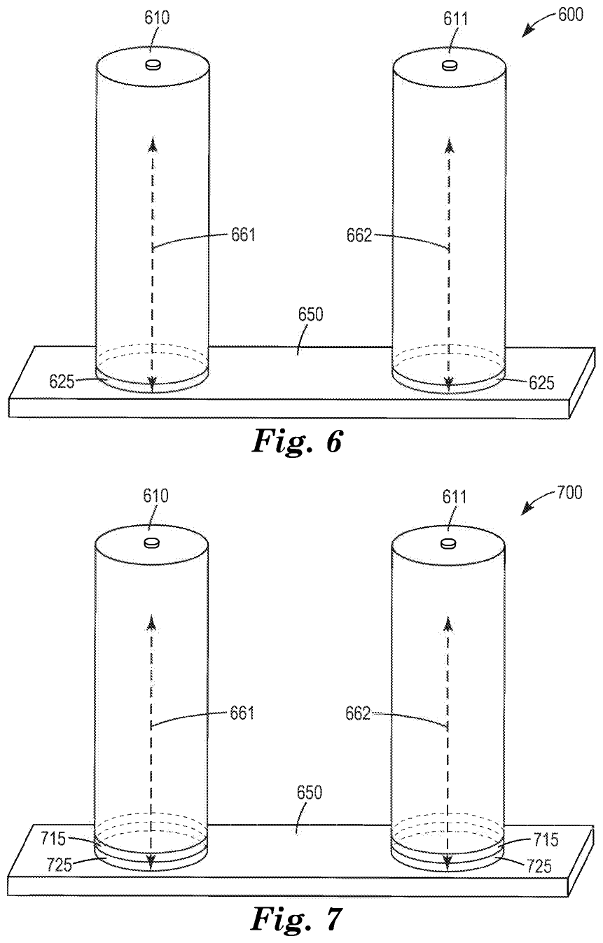

Referring now to FIG. 7, thermal management assembly 700 comprises first electrochemical cell 610 and second electrochemical cell 611. Thermal conductor (e.g. layer) 715 and expandable material (e.g. layer) 725 is disposed between each electrochemical cells and the heat exchange member 650. Thermal pathways 661 and 662 extend from the electrochemical cells to the heat exchange member 650 passing through thermal conductor (e.g. layer) 715 and expandable material (e.g. layer) 725.

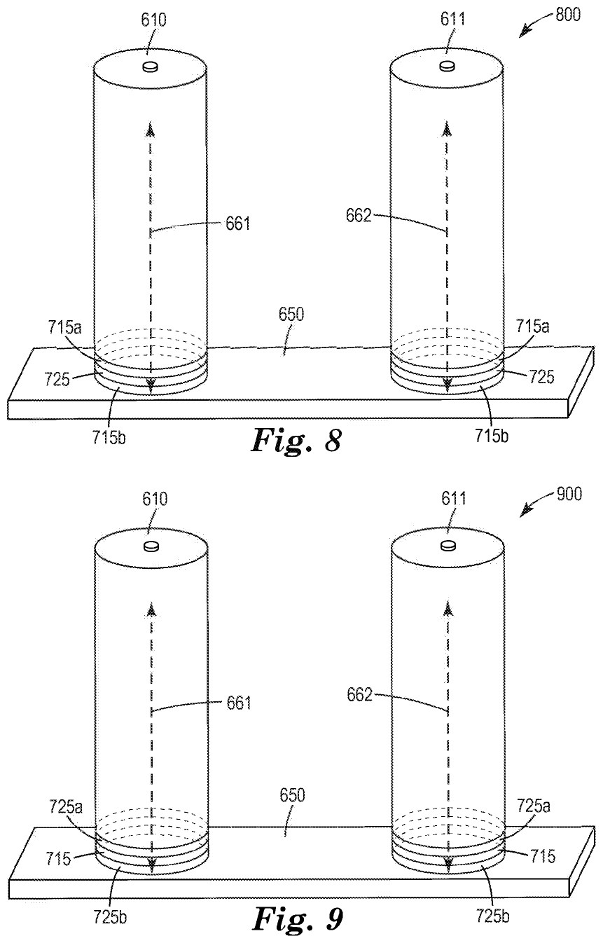

FIG. 8 shows another thermal management assembly 800. Thermal management assembly 800 is similar to FIG. 7 comprising thermal conductor (e.g. layer) 715a between the electrochemical cells 610 and 611 and expandable material (e.g. layer) 725 and a second thermal conductor layer 715b between expandable material (e.g. layer) 725 and heat exchange member 650.

FIG. 9 shows another thermal management assembly 900. Thermal management assembly 900 is similar to FIG. 8 comprising expandable material (e.g. layer) 725a between the electrochemical cells 610 and 611 and thermal conductor layer 715 and expandable material (e.g. layer) 725b between the thermal conductor layer 715 and heat exchange member 650.

FIG. 10 shows another thermal management assembly 1000. Thermal management assembly 1000 is similar to FIG. 6 further comprising expandable material 625 between the electrochemical cells. The expandable material 625 between the electrochemical cells 610,611 and the heat exchange member 650 is inlaid (not shown) into heat exchange member 650. The expandable material between the electrochemical cells can be the thermal management article of FIG. 1 or 2. The expandable material between the electrochemical cells can further comprise additional thermal conductor or expandable layers such as depicted in FIG. 7, FIG. 8 and FIG. 9. An additional (e.g. third) thermal pathway 663 extends from electrochemical cell 610 to electrochemical cell 611.

In some embodiments, the first and second expandable materials are portions of a discontiguous expandable material, such as a continuous layer, as shown in FIG. 6-10. Alternatively, the first and second expandable material can be contiguous as shown in FIG. 5.

In typical embodiments, illustrated by FIGS. 6-10, the expandable material between the first and second electrochemical cells and heat exchange member is depicted as being the same. It is appreciated, that the expandable materials can be different.

The present invention is also directed to methods of making a thermal management assembly comprising providing a (e.g. first) expandable material between a first electrochemical cell and a heat exchange member and providing a (e.g. second) expandable material between a second electrochemical cell a heat exchange member wherein the expandable materials comprises intumescent particles that expands at an expansion temperature range as described herein. In some embodiments, the expandable material is provided as a sheet, film, or tape.

The present invention is also directed to a method of using of a thermal management assembly comprising: i) providing a thermal management assembly as described herein and illustrated by FIGS. 5-11; ii) exposing the first and second thermal pathways to a temperature within the onset temperature range; and iii) exposing the first thermal pathway to a second temperature greater than the expansion temperature range while the second thermal pathway of the second electrochemical cell is within the expansion temperature range thereby decreasing the thermal impedance of the first thermal pathway while increasing the thermal impedance of the second thermal pathway.

Objects and advantages of this disclosure are further illustrated by the following non-limiting examples, but the particular materials and amounts thereof recited in these examples, as well as other conditions and details, should not be construed to unduly limit this disclosure.

### Examples

Unless otherwise noted, all parts, percentages, ratios, etc. in the Examples and the rest of the specification are by weight.

MATERIALS

| DESIGNATION | DESCRIPTION | SOURCE |
|---|---|---|
| EHA | Ethylhexyl acrylate | obtained from BASF, |
| | | Florham Park, New |
| | | Jersey |
| HDDA | Hexanediol diacrylate | obtained as SR 238 from |
| | | Sartomer, Exton, |
| | | Pennsylvania |
| IRG 651 | 2,2-Dimethoxy-1,2-diphenylethan-1-one | obtained as IRGACURE |
| | photoinitiator | 651 from BASF |
| IRG 819 | Bis(2,4,6-trimethylbenzoyl)phenylphosphine | obtained as IRGACURE |
| | oxide photoinitiator | 819 from BASF |
| BAK70 | Spherical alumina, D₅₀~70 micron | obtained from Bestry, |
| | | Shanghai, China |
| BAK10 | Spherical alumina, D₅₀~10 micron | obtained from Bestry |
| TM1250 | Semi-spherical alumina, D₅₀~1.2 micron | obtained from Huber, |
| | | Atlanta, Georgia |
| U018-130D | Expandable microspheres, having a | obtained as DUALITE |
| | polyvinylidene chloride shell Tonset = 90-95° C. | U018-130D from Chase |
| | Tmax 130-140° C. | Corporation, Westwood, |
| | | Massachusetts |
| RF32N | PET coated release liner | obtained from SKC Haas, |
| | | Shenzhen City, China |

### Base Syrup

Base syrup was prepared by combining 350 g of EHA and 0.14 g of IRG 651 in a one-quart glass jar and mixed using a high shear electric motor until a homogeneous mixture was obtained. The resultantmixture was degassed for five minutes by bubbling nitrogen through a tube inserted in an opening of the lid. While stirring, the mixture was exposed to UVA light until a pre-adhesive syrup having a viscosity deemed suitable for coating was formed. Following UV exposure, air was introduced into the jar. This prepolymer was then mixed with 0.22 part per hundred (phr) of HDDA and 0.43 phr of IRG 819 to form the final base syrup formulation.

### Comparative (Non-Expandable) Non-Conductive Layer

The Base Syrup was coated between two RF32N liners using a notched bar coater at a nominal gap of 100 microns. The coating was cured by exposing the PET surface to UVA energy.

### (Non-Expandable) Thermally Conductive Layer

The coating solution was prepared by mixing 12.6 parts by weight of the Base Syrup, 52.4 parts by weight BAK70, 17.5 parts by weight BAK10, and 17.5 parts by weight TM1250 under high shear and partial vacuum (10 mbar). The solution was then coated between two RF32N liners using a notched bar coater at a nominal gap of 500 microns. The coating was cured by exposing the PET surface to UVA energy.

### Expandable Layer A

A coating solution was prepared by mixing 95.2 parts by weight of the Base Syrup and 4.8 parts by weight U018-130D under high shear and partial vacuum (10 mbar). The solution was then coated between two RF32N liners using a notched bar coater at a nominal gap of 100 microns. The coating was cured by exposing the PET surface to UVA energy.

### Expandable Layer B

A coating solution was prepared by mixing 90.9 parts by weight Base syrup and 9.1 parts by weight U018-130D under high shear and partial vacuum (10 mbar). The solution was then coated between two RF32N liners using a notched bar coater at a nominal gap of 100 microns. The coating was 15 cured by exposing the PET surface to UVA energy.

### Expandable Layer C

The coating solution was prepared by mixing 87.0 parts by weight of Base Syrup and 13.0 parts by weight U018-130D under high shear and partial vacuum (10 mbar). The solution was then coated between two RF32N liners using a notched bar coater at a nominal gap of 100 microns. The coating was cured by exposing the PET surface to UVA energy.

### Expandable Layer D

The coating solution was prepared by mixing 83.3 parts by weight of Base Syrup and 16.7 parts by weight of U018-130D under high shear and partial vacuum (10 mbar). The solution was then coated between two RF32N liners using a notched bar coater at a nominal gap of 100 microns. The coating was cured by exposing the PET surface to UVA energy.

Expandable Layer E The coating solution was prepared by mixing 80.0 parts by weight of Base syrup and 20.0 parts by weight U018-130D under high shear and partial vacuum (10 mbar). The solution was then coated between two RF32N liners using a notched bar coater at a nominal gap of 100 microns. The coating was cured by exposing the PET surface to UVA energy.

### Example 1 (EX-1)

An approximately 2 in×2 in (5.1 cm×5.1 cm) square was cut from the cured Expandable Layer A and two 2 in×2 in (5.1 cm×5.1 cm) squares were cut from the cured Thermally Conductive Layer.

After removing the PET liner from one face of the Expandable Layer A and one of the Thermally Conductive Layer squares, the squares were then laminated together using a hand-held roller to remove air. The PET liner was then removed from the exposed face of the Expandable Layer and from one face of the remaining Thermally Conductive Layer squares. The Thermally Conductive Layer was then laminated to the exposed face of the Expandable Layer using a hand-held roller to obtain the final multilayer construction.

### Example 2 (EX-2)

EX-2 was constructed following the same procedure as EX-1, except using Expandable Layer B in place of Expandable Layer A.

### Example 3 (EX-3)

EX-3 was constructed following the same procedure as EX-1, except using Expandable Layer C in place of Expandable Layer A.

### Example 4 (EX-4)

EX-4 was constructed following the same procedure as EX-1, except using Expandable Layer D in place of Expandable Layer A.

### Example 5 (EX-5)

EX-5 was constructed following the same procedure as EX-1, except using Expandable Layer E in place of Expandable Layer A.

### Example 6 (EX-6)

EX-6 was EX-1 constructed as a single expandable layer. The coating solution was prepared by mixing 6.25 g of Base Syrup, 20.25 g of BAK70, 6.75 g of BAK10, 6.75 g of TM1250, and 0.064 g of

U018-130D under high shear and partial vacuum (10 mbar). The solution was then coated between two
RF32N liners using a notched bar coater at a nominal gap of 500 microns. The coating was cured by
exposing the PET surface to UVA.

### Example 7 (EX-7)

EX-7 was EX-2 constructed as a single expandable layer. The coating solution was prepared by mixing 6.25 g of Base Syrup, 20.25 g of BAK70, 6.75 g of BAK10, 6.75 g of TM1250, 0.122 g of U018-130D under high shear and partial vacuum (10 mbar). The solution was then coated between two RF32N liners using a notched bar coater at a nominal gap of 500 microns. The coating was cured by exposing the PET surface to UVA.

### Example 8 (EX-8)

EX-8 was EX-3 constructed as a single expandable layer. The coating solution was prepared by mixing 6.25 g Base Syrup, 20.25 g of BAK70, 6.75 g of BAK10, 6.75 g of TM1250, and 0.176 g of U018-130D under high shear and partial vacuum (10 mbar). The solution was then coated between two RF32N liners using a notched bar coater at a nominal gap of 500 microns. The coating was cured by exposing the PET surface to UVA.

### Example 9 (EX-9)

EX-9 was EX-4 constructed as a single expandable layer. The coating solution was prepared by mixing 6.25 g of Base syrup, 20.25 g of BAK70, 6.75 g of BAK10, 6.75 g of TM1250, and 0.224 g of U018-130D under high shear and partial vacuum (10 mbar). The solution was then coated between two RF32N liners using a notched bar coater at a nominal gap of 500 microns. The coating was cured by exposing the PET surface to UVA energy.

### Example 10 (EX-10)

EX-10 was EX-5 constructed as a single expandable layer. The coating solution was prepared by mixing 6.25 g of Base Syrup, 20.25 g of BAK70, 6.75 g of BAK10, 6.75 g of TM1250, and 0.269 g of U018-130D under high shear and partial vacuum (10 mbar). The solution was then coated between two RF32N liners using a notched bar coater at a nominal gap of 500 microns. The coating was cured by exposing the PET surface to UVA energy.

### Comparative Example 1 (CE-1)

CE-1 was a multilayered structure lacking expandable material. CE-1 was constructed by cutting an approximately 2.5 in×2.5 in (6.4 cm×6.4 cm) square from the cured Comparative Non-Conductive Layer and two 2.5 in×2.5 in (6.4 cm×6.4 cm) squares were cut from the cured Thermally Conductive Layer. After removing the PET liner from one face of the Comparative Non-Conductive Layer and one of the Thermally Conductive Layer squares, the squares were then laminated together using a hand-held roller to remove air. The PET liner was then removed from the exposed face of the Comparative Non-Conductive Layer and from one face of the remaining Thermally Conductive Layer squares. The Thermally Conductive Layer was then laminated to the exposed face of the Comparative Non-Conductive Layer using a hand-held roller to obtain the final multilayer construction.

### COMPARATIVE Example 2 (CE-2)

CE-1 was a thermally conductive layer lacking expandable material. CE-2 was constructed by laminating four layers of the Thermally Conductive Layer together.

### Test Methods

### Measurement of Apparent Thermal Conductivity

The apparent thermal conductivity was determined according to the following procedure. Circular discs of 33 mm in diameter were punched from a layer or multilayer construction either before or after thermal expansion. After the releasable liner was removed from both faces of the punched sample, the disc was placed on the bottom plate of the TIM Tester (Analysis Tech, Wakefield, Massachusetts) and the top plate was slowly lowered into contact with the top surface of the sample and the minimum allowable pressure (<10 psi) was applied. The top plate was heated and bottom plate cooled until a temperature gradient was established with an average sample temperature of 50° C. The apparent thermal conductivity was calculated by dividing the sample thickness by the thermal impedance. The reported value includes the contact resistance from the interface between each plate and the sample surfaces.

### Expansion

Circular discs of 33 mm in diameter were punched from the multilayer constructions. Discs were placed in an aluminum pan and placed in a Batch oven set at 130° C. After 5 minutes, the samples were removed and the apparent thermal conductivity was measured following the methods described above. Results are reported in Table 2.

In Table 2, all the examples exhibit a decrease in thermal conductivity after expansion and an apparent thermal conductivity ratio of less than 1. Notably, multilayer samples that exhibit significant delamination after expansion (i.e. EX-4 and EX-5) exhibit a greater decrease in thermal conductivity and lower thermal conductivity ratio compared with the same compositions prepared as a single layer (i.e. EX-9 and EX-10).

TABLE 2

| | Apparent | Apparent | | |
|---|---|---|---|---|
| | Thermal | Thermal | Apparent | Shear |
| Example/ | Conductivity | Conductivity | Thermal | Delamination |
| Comparative | as-cast, | after Expansion, | Conductivity | by Visual |
| Example | W · m⁻¹K⁻¹ | W · m⁻¹K⁻¹ | Ratio | Inspection |
| EX-1 | 1.18 | 0.992 | 0.84 | No |
| EX-2 | 1.08 | 0.660 | 0.61 | No |
| EX-3 | 1.09 | 0.362 | 0.33 | Yes (Partial) |
| EX-4 | 1.07 | 0.115 | 0.11 | Yes |
| | | | | (Significant) |
| EX-5 | 1.10 | 0.114 | 0.10 | Yes |
| | | | | (Significant) |
| EX-6 | 1.64 | 1.32 | 0.80 | N/A |
| EX-7 | 1.57 | 1.16 | 0.74 | N/A |
| EX-8 | 1.68 | 1.07 | 0.64 | N/A |
| EX-9 | 1.62 | 1.03 | 0.64 | N/A |
| EX-10 | 1.54 | 0.95 | 0.61 | N/A |

### Measurement of Thermal Impedance

The through-plane thermal impedance of the samples was determined according to the following procedure, in accordance with ASTM E1530. Circular discs of 50 mm in diameter were punched out from the multilayer constructions. The releasable liners from both faces were removed and were replaced instead with a thin film (0.025 mm) of copper foil. The sample was then placed on the bottom plate of the DTC-300 (TA Instruments, New Castle, Delaware) and the top plate was lowered into contact with the top surface of the sample subject to either 100 kPa of applied pressure or with the pneumatics in the top plate disengaged, as described for each Example or Comparative Example (for any tests without applied pressure relaxing the pressure to ˜11 kPa (determined by estimating the weight of the test head). Temperature control was subsequently engaged for the top plate and bottom plate. For each thermal impedance measurement, a temperature gradient was established to achieve a 30° C. differential across the sample where the upper plate is the hotter side relative to the lower plate. Measurements of the heat flow across the sample were taken at the following average sample temperatures in series: 50, 70, 80, 90, 100, 110, 120, 140 and 160° C. A guard heater around the sample was also heated to the average sample temperature for each measurement. Heat flow measurements were taken once thermal equilibrium was established (after ˜1 hr). The thermal impedance (I) was calculated based on the area of the heating plates (A), the measured temperature differential (ΔT) and the measured heat flow (Q): I=Δ·ΔT·Q⁻¹. The thermal impedance is defined as the sum of the thermal resistance of the sample plus any contact resistance contributions from the interfaces (e.g. plate/copper foil, copper foil/sample). The thermal impedance at various temperatures is reported in Table 3. Percent change is defined as (I_{final}−Iᵢₙᵢₜᵢₐₗ)/Iᵢₙᵢₜᵢₐₗ*100. Percent change in temperature ranges 50-90° C. and 90-110° C. for Examples and Comparative Examples is presented in Table 4.

TABLE 3

| | Thermal Impedance [m²K/W] | | | | | | |
|---|---|---|---|---|---|---|---|
| Setpoint | | | EX-5 | | | | |
| Temperature | | | Pneumatics | | | | |
| (° C.) | EX-1 | EX-5 | off | EX-6 | EX-10 | CE−1 | CE−2 |
| 50 | 5.27E−04 | 6.59E−04 | 9.70E−04 | 2.72E−04 | 2.66E−04 | 7.63E−04 | 5.56E−04 |
| 70 | 7.78E−04 | 1.27E−03 | 1.45E−03 | 4.14E−04 | 4.88E−04 | 8.68E−04 | 6.59E−04 |
| 80 | 1.09E−03 | 2.47E−03 | 2.72E−03 | 5.09E−04 | 6.35E−04 | 9.16E−04 | 6.56E−04 |
| 90 | 1.17E−03 | 3.18E−03 | 3.89E−03 | 5.62E−04 | 5.92E−04 | 9.77E−04 | 7.23E−04 |
| 100 | 8.47E−04 | 1.12E−03 | 2.77E−03 | 5.23E−04 | 3.97E−04 | 9.79E−04 | 7.23E−04 |
| 110 | 8.32E−04 | 1.04E−03 | 1.58E−03 | 5.36E−04 | 3.76E−04 | 1.02E−03 | 7.79E−04 |
| 120 | 8.75E−04 | 1.05E−03 | 1.46E−03 | 5.74E−04 | 4.02E−04 | 1.06E−03 | 8.26E−04 |
| 140 | 9.19E−04 | 1.09E−03 | 1.36E−03 | 6.19E−04 | 4.58E−04 | 1.12E−03 | 8.79E−04 |
| 160 | 1.00E−03 | 1.18E−03 | 1.36E−03 | 6.99E−04 | 5.99E−04 | 1.20E−03 | 9.61E−04 |

TABLE 4

| EX/CE | (I₉₀ − I₅₀)/I₅₀ | (I₁₁₀ − I₉₀)/I₉₀ |
|---|---|---|
| EX-1 | 122% | −29% |
| EX-5 | 383% | −67% |
| EX-5 | 301% | −59% |
| Pneumatics off | | |
| EX-10 | 123% | −36% |
| CE-1 | 28% | 4% |
| CE-2 | 30% | 8% |

1. A thermal management assembly comprising:
a first thermal pathway comprising a first expandable material disposed between a first electrochemical cell and a first heat exchange member; and
a second thermal pathway comprising a second expandable material disposed between a second electrochemical cell and a second heat exchange member; and
wherein the first and second expandable materials independently comprise intumescent particles dispersed in an organic binder and the first and second expandable materials expand at a first expansion temperature range and a second expansion temperature range respectively.

2. The thermal management assembly of claim 1 wherein the first and/or second expandable materials further comprise thermally conductive particles.

3. The thermal management assembly of claim 1 further comprising one or more thermal conductor(s) in contact with the expandable material.

4. The thermal management assembly of claim 1 wherein the first and second expandable materials are portions of a contiguous expandable material.

5. The thermal management assembly of claim 1 wherein the first and second heat exchange members are portions of a contiguous heat exchange member.

6. The thermal management assembly of claim 1 wherein when heated to a first temperature of the first expansion temperature range, the first expandable material expands thereby decreasing in apparent thermal conductivity and the first thermal pathway increases in thermal impedance.

7. The thermal management assembly of claim 1 wherein when heated to a first temperature of the first expansion temperature range the first expandable material expands such that it delaminates from the first electrochemical cell, first heat exchange member, and/or thermal conductor.

8. The thermal management assembly of claim 1 wherein the first and second expansion temperature ranges of the first and second expandable materials are in the range of 80° C. to 285° C.

9. The thermal management assembly of claim 1 wherein the intumescent particles have an expansion temperature range with a maximum temperature of less than 155, 150, 145, or 140° C.

10. The thermal management assembly of claim 1 wherein the intumescent particles have an expansion temperature range with an onset temperature range with a minimum temperature of less than 110, 105, 100, 95, 90, 85, or 80° C.

11. The thermal management assembly of claim 1 wherein when heated to a second temperature, greater than the first expansion temperature range, the first expandable material contracts thereby increasing in apparent thermal conductivity and the first thermal pathway decreases in thermal impedance.

12. The thermal management assembly of claim 11 wherein the second temperature is less than 180, 170, 160, 150, 140, 130, 120, 110, or 100° C.

13. The thermal management assembly of claim 11 wherein during thermal runaway the first expandable material reaches the second temperature while the second expandable material is within the second expansion temperature range thereby decreasing the thermal impedance of the first thermal pathway while increasing the thermal impedance of the second thermal pathway.

14. The thermal management assembly of claim 1 wherein the first and/or second expandable material comprises expandable polymer microspheres.

15. The thermal management assembly of claim 1 wherein the first and/or second expandable material comprises greater than 70, 75, 80, 85, 90, 95, or 99 wt. % of expandable polymeric microspheres based on the total amount of intumescent particles.

16. The thermal management assembly of claim 1 wherein the first and/or second expandable material comprise less than 30, 25, 20, 15, 10, 5, or 1 wt. % of expandable graphite based on the total amount of intumescent particles.

17. The thermal management assembly of claim 2 wherein the organic binder comprise an acrylic polymer.

18. The thermal management assembly of claim 2 wherein the organic binder lacks siloxane moieties and has a Tg less than 0° C.

19. The thermal management assembly of claim 2 wherein the organic binder is a pressure sensitive adhesive.

20. The thermal management assembly of claim 1 wherein the first and/or second expandable material is in the form of one or more layers of a film or sheet inclusive of multilayer films and multilayer sheets.

21-29. (canceled)
